(19) United States
(12) Patent Application Publication
(10) Pub. No.: US 2011/0263728 A1
(43) Pub. Date: Oct. 27, 2011

(54) RECYCLED LATEX FOAM MATERIAL AND ITS PREPARATION METHOD

(75) Inventor: Heng-Tai CHANG, Taichung City (TW)

(73) Assignee: SIX-VICTOR LTD., Taichung City (TW)

(21) Appl. No.: 13/016,194

(22) Filed: Jan. 28, 2011

(30) Foreign Application Priority Data
Jan. 29, 2010 (TW) 99102736

(51) Int. Cl. C08J 9/35; C08L 21/02; C08J 11/04; B29C 71/00; C08L 75/14

(52) U.S. Cl. 521/42; 264/237; 521/137

(57) ABSTRACT

A recycled latex foam material is prepared by mixing polyurethane with recycled waste latex grains to cause a polymerization reaction and then feeding the polymerized recycled waste latex foam grains and polyurethane mixture into a mold for molding into a finished product. The method of the invention is environmentally friendly and practical for making latex foam pads of different hardnesses and densities for different application purposes by using different grain sizes of recycled waste latex grains with polyurethane. The finished product has comfort wearing, breathing, anti-slip, anti-bacterial and cost-saving characteristics.

### BACKGROUND OF THE INVENTION

1. Field of the Invention The present invention relates to latex foam pad fabrication technology and more particularly, to the preparation of a latex foam pad using recycled waste latex foam fragments.

2. Description of the Related Art

Conventional latex foam pads (such as bed pads, pillow pads and shoe pads) are highly invited by consumers for the advantages of high density and high rebound resilience characteristics.

However, many waste latex foam fragments will be left in the fabrication of latex foam pads. These waste latex foam fragments will be directly discarded after the fabrication of latex foam pads. Discharging waste latex foam fragments may cause environmental pollution and will increase the material cost. In consequence, conventional latex foam pads are selling at a high price level.

### SUMMARY OF THE INVENTION

The present invention has been accomplished under the circumstances in view. It is the main object of the present invention to provide a recycled latex foam material and its preparation method, which utilizes recycled waste latex foam fragments for making latex foam pads of different densities and hardnesses that have comfort wearing, breathing, anti-slip, anti-bacterial and cost-saving characteristics.

To achieve this and other objects of the present invention, the recycled latex foam material preparation method includes the step of mixing polyurethane with recycled waste latex grains to cause a polymerization reaction, and the step of feeding the polymerized recycled waste latex foam grains and polyurethane mixture into a mold for molding into a finished product.

Further, the recycled waste latex grains used have a grain size within the range of 1 mm˜35 mm.

Further, the recycled waste latex grains used are treated through a weight measurement step after crushing and screening.

Further, the step of feeding the polymerized recycled waste latex foam grains and polyurethane mixture into a mold for molding into a finished product is done by means of: feeding the polymerized recycled waste latex foam grains and polyurethane mixture into a mold for molding into a molded product, and then cooling down the mold to have the molded product be hardened, and then removing the hardened molded product from the mold, and then heating the finished product at a predetermined temperature to a dry status.

To achieve this and other objects of the present invention, a recycled waste latex foam material comprises multiple irregularly shaped latex foam grains that are bonded together, having breathing and anti-slip characteristics.

### BRIEF DESCRIPTION OF THE DRAWINGS

The patent or application file contains at least one drawing executed in color. Copies of this patent or patent application publication with color drawings will be provided by the Office upon request and payment of the necessary fee.

FIG. 1 is a latex foam pad preparation flow chart according to the present invention.

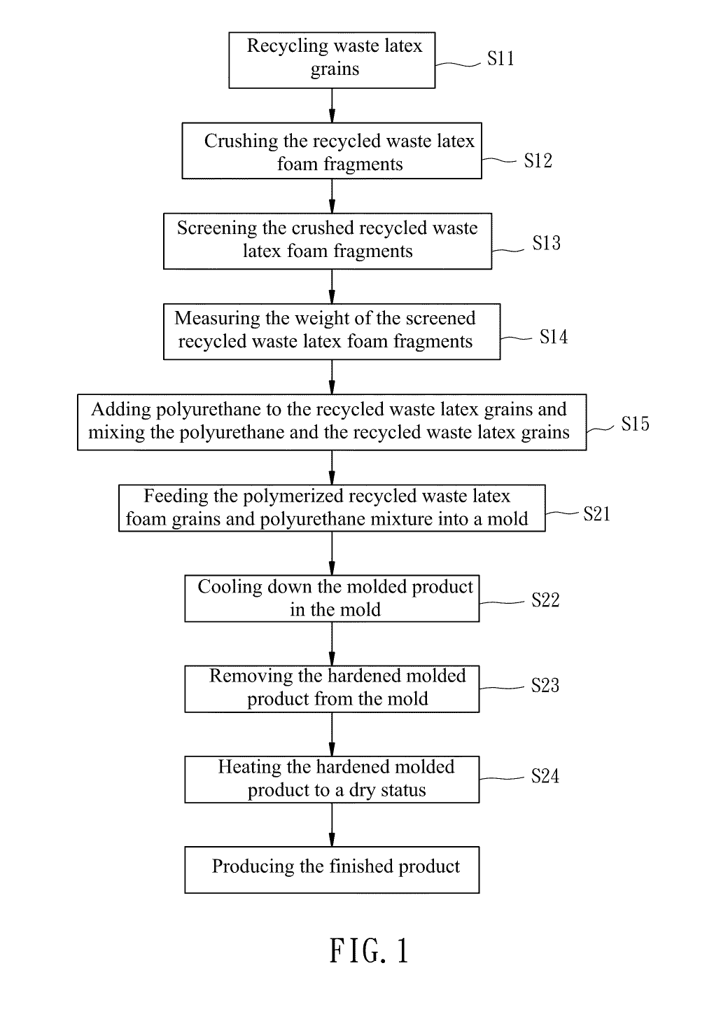

FIG. 2 is a schematic plain view of a latex foam pad made according to the present invention.

FIG. 3 is a color picture of the latex foam pad 10.

### DETAILED DESCRIPTION OF THE INVENTION

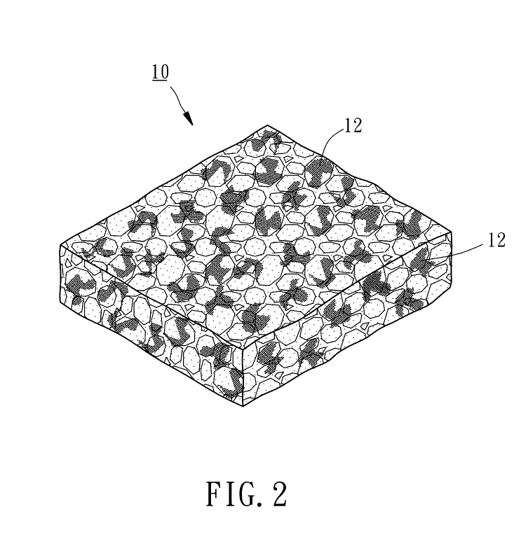

Referring to FIG. 2, the present invention provides a latex foam pad 10 that is block-shaped and formed by bonding multiple irregularly shaped latex foam grains 12 together. The latex foam grains 12 have a grain size within the range of 1 mm˜35mm

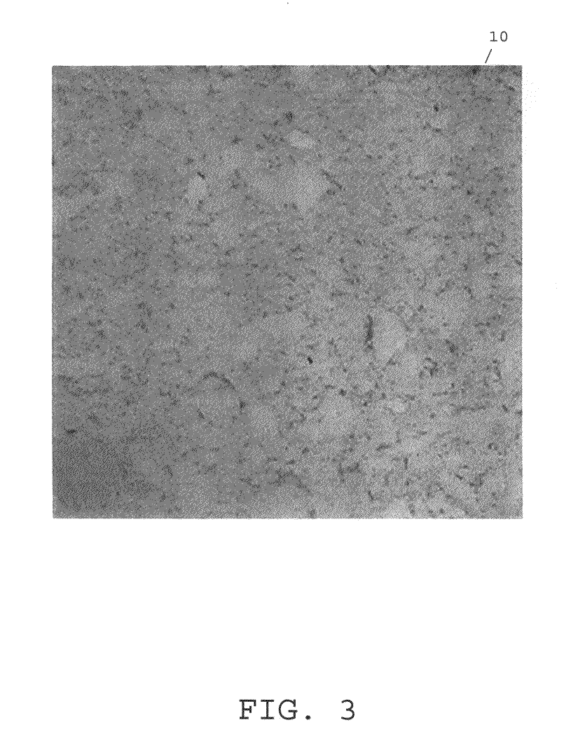

Because it is difficult to explain the structure of the latex foam pad 10 by means of illustration, a color picture of the latex foam pad 10 is attached for reference as FIG. 3.

The preparation of the latex foam pad 10 includes the steps as follows:

Step a): add polyurethane to recycled waste latex grains and well mix them together (S15), enabling the recycled waste latex grains and the applied polyurethane to cause a polymerization reaction; and

Step b): feed the polymerized recycled waste latex foam grains and polyurethane mixture into a mold for molding into a finished product.

In the aforesaid Step a), the recycled waste latex grains have a grain size within the range of 1 mm˜35 mm The recycled waste latex foam material is obtained through a series of steps including the step of recycling waste latex foam fragments (S11), the step of crushing the recycled waste latex foam fragments (S12), the step of screening the crushed recycled waste latex foam fragments (S13) and the step of weight measurement (S14). Further, the added polyurethane is obtained by means of polymerizing methylenediphenyl diiocyanate (MDI) and polyoxypropylene glycol (PPG).

In the aforesaid Step b), the polymerized recycled waste latex foam grains and polyurethane mixture is fed into a mold (S21) for molding into a finished product. After the mold is cooled down (S22), the molded product is hardened and removed from the mold (S23), and then the molded product is heated at a predetermined temperature to a dry status (S24), and the desired latex foam pad 10 is thus obtained. The latex foam pad 10 contains 70%˜90% latex foam grains, 15%˜5% polymerize methylenediphenyl diiocyanate (MDI) and 15%˜5% polyoxypropylene glycol (PPG).

As stated above, the method of the present invention is practical for making latex foam pads of different hardnesses and densities for different application purposes by using different grain sizes of recycled waste latex grains with polyurethane. For example, for making a latex foam mattress, the density of the finished product is within the range of 50 kg/m³˜150 kg/m³; for making a latex foam shoe pad, the hardness of the finished product is the range of shore hardness C type 5˜45. Using recycled waste latex grains for making a latex foam pad is environmentally friendly. Further, a latex foam pad made according to the present invention has comfort wearing, breathing, anti-slip, anti-bacterial and cost-saving characteristics.

Although one particular embodiment of the invention has been described in detail for purposes of illustration, various modifications and enhancements may be made without departing from the spirit and scope of the invention. Accordingly, the invention is not to be limited except as by the appended claims.

What is claimed is:

1. A recycled waste latex foam material, comprising a pad body formed of multiple irregularly shaped latex foam grains that are bonded together.

2. The recycled waste latex foam material as claimed in claim 1, wherein said latex foam grains have a grain size within the range of 1 mm˜35 mm

3. The recycled waste latex foam material as claimed in claim 1, wherein said latex foam pad is block-shaped.

4. A recycled waste latex foam material preparation method, comprising the steps of:
a): adding polyurethane to recycled waste latex grains and well mixing said polyurethane and said recycled waste latex grains for causing a polymerization reaction to form a polymerized recycled waste latex form grains and polyurethane mixture; and
b): feeding said polymerized recycled waste latex foam grains and polyurethane mixture into a mold for molding into a finished product.

5. The recycled waste latex foam material preparation method as claimed in claim 4, wherein said recycled waste latex grains prepared in step a) are obtained by crushing a recycled waste latex foam fragments and screening the crushed recycled waste latex foam fragments.

6. The recycled waste latex foam material preparation method as claimed in claim 5, wherein said recycled waste latex grains used in step a) are treated through a weight measurement step after crushing and screening.

7. The recycled waste latex foam material preparation method as claimed in claim 4, wherein said step b) of feeding said polymerized recycled waste latex foam grains and polyurethane mixture into a mold for molding into a finished product is done by means of feeding said polymerized recycled waste latex foam grains and polyurethane mixture into a mold for molding into a molded product, and then cooling down the molded product in the mold to a hardened status, and then removing the hardened molded product from the mold.

8. The recycled waste latex foam material preparation method as claimed in claim 7, wherein said step b) further comprises a sub-step of heating the finished product at a predetermined temperature to a dry status after removal of the finished product from the mold.

9. The recycled waste latex foam material preparation method as claimed in claim 4, wherein the recycled waste latex grains used in step a) have a grain size within the range of 1 mm˜35 mm.

10. The recycled waste latex foam material preparation method as claimed in claim 4, wherein the polyurethane used in said step a) is obtained by means of polymerizing methylenediphenyl diiocyanate (MDI) and polyoxypropylene glycol (PPG).

11. The recycled waste latex foam material preparation method as claimed in claim 10, wherein the recycled waste latex foam material contains 70%˜90% latex foam grains, 15%˜5% polymerize methylenediphenyl diiocyanate (MDI) and 15%˜5% polyoxypropylene glycol (PPG).

12. A recycled waste latex foam pad made according to the recycled waste latex foam material preparation method as claimed in claim 4.
